(19) United States
(12) Patent Application Publication
(10) Pub. No.: US 2010/0188860 A1
(43) Pub. Date: Jul. 29, 2010

(54) LOTUS BLOSSOM HEAT DISSIPATING DEVICE

(76) Inventor: Been-Yu LIAW, Sindian City (TW)

Correspondence Address: Muncy, Geissler, Olds & Lowe, PLLC, 4000 Legato Road, Suite 310, FAIRFAX, VA, 22033, US

(21) Appl. No.: 12/360,996

(22) Filed: Jan. 28, 2009

(51) Int. Cl. F21V 29/00

(52) U.S. Cl. 362/373

(57) ABSTRACT

The present invention relates to a lotus blossom heat dissipating device, wherein a heat dissipating device is structured from a circuit substrate and at least one heat dissipating plate, one side of which is connected to the back of the circuit substrate. The heat dissipating plate conducts away the heat produced by light-emitting elements, and a stacking method is used to additionally assemble a plurality of the heat dissipating plates. The circuit substrate is mounted with at least one light-emitting element, from which extend electric conducting electrical elements. The circuit substrate has a plurality of holes, the heat dissipating plates having coinciding holes corresponding to the plurality of holes, with the electrical elements penetrating the aforementioned holes. Accordingly, heat produced from the activated light-emitting elements is quickly conducted away through the heat dissipating plates, thereby providing a simple structure, and achieving the objective of saving on costs.

### BACKGROUND OF THE INVENTION

(a) Field of the Invention

The present invention provides a heat dissipating device, and more particularly provides a lotus blossom heat dissipating device having a simple structure and small size, which achieves the objective of saving on cost.

(b) Description of the Prior Art

Because the light-emitting diode (LED) is a solid-state semiconductor element, thus, interoperability of electron holes is used to release energy in light form, and belongs to luminescence. Moreover, advantages of the LED include small size, fast response speed, long serviceable life, low power consumption, superior resistance to shock and non-polluting. Light-emitting elements are presently already widely utilized in many areas, including electric appliances, information billboards, communication products, and the like, in particular, current lighting equipment which use light-emitting diodes as light-emitting elements. Although the efficiency of the first light-emitting diodes was lower than anticipated compared with traditional lighting equipment, however, subsequent improvements in technology and material have brought about substantial progress in the luminance brightness of light-emitting diodes currently manufactured, which has effected the gradual replacement of traditional light-emitting elements.

Furthermore, under the influence of subsequent technology and material, electric current required by light-emitting diodes has progressively increased, thus, the heat energy produced by light-emitting diodes has also gradually increased. Hence, in order to prevent excessive heat energy from affecting the serviceable life of the light-emitting diodes, lighting equipment already using light-emitting diodes as the light-emitting elements are installed with an appropriate heat dissipating structure, and such means has become one of the essential measures to prevent excessive heat energy in current lighting devices.

Hence, in order to resolve the heat dissipation problems of lighting devices, prior art provided the technology to enable the lighting devices, functioning in coordination with the design thereof, to be installed with a plurality of heat dissipating fins, using mutual coordination between conduction and air cooled heat dissipation to conduct the heat energy produced by the lighting device to the plurality of heat dissipating fins, whereupon heat exchange is effected between the air and heat dissipating fins, thereby decreasing the affect the heat energy has on the lighting device. Referring to FIG. 1, which shows a heat dissipating structure for a LED light fitting of the prior art, and it can be clearly seen from the drawing that a heat dissipating structure 1 comprises a plurality of fins 11, and the fins 11 are connected together in tandem using a fastening means to form the completed heat dissipating structure 1. The fins 11 use fastening pieces to increase the heat dissipating surface within a limited range to achieve the desired heat dissipation effect.

However, the following problems and shortcomings are still in need of improvement when using the aforementioned heat dissipating structure for a LED light fitting of the prior art:

1. The mold required when manufacturing the heat dissipating structure 1 is relatively expensive.

2. The structure is complex, resulting in a relatively long manufacturing time.

3. High cost, large size.

### SUMMARY OF THE INVENTION

Hence, in light of the shortcomings of the aforementioned prior art, the inventor of the present invention, having collected related data, has designed a new lotus blossom heat dissipating device having a simple structure, small size, short manufacturing time and low cost.

The primary objective of the present invention lies in: A lotus blossom heat dissipating device comprising a circuit substrate, on which is mounted at least one light-emitting element, and an electrical element used to realize electric conduction extends from each of the light-emitting elements. The circuit substrate is provided with a plurality of holes to enable the electrical elements to pass therethrough, and at least one heat dissipating plate is located on the reverse side of the circuit substrate. A stacking method is used to additionally assemble a plurality of the heat dissipating plates, and the heat dissipating plates are further provided with coinciding holes corresponding to the plurality of holes. The electrical elements penetrate the coinciding holes after penetrating the holes. Accordingly, when an electric current flows through the electrical elements to the light-emitting elements, then the light-emitting elements immediately light up and begin producing heat energy, whereupon, the heat energy is quickly conducted away through the heat dissipating plates, thereby extending the serviceable life of the light-emitting elements. Moreover, the more the number of the heat dissipating plates stacked together, the better the heat dissipation effectiveness. According to the art described above, the present invention provides a breakthrough in solving the existing problems of prior art heat dissipating structures for LED light fittings, which include the relatively high-price of the mold required when manufacturing the heat dissipating structure and its complex structure, resulting in a relatively long manufacturing time, high cost and large size, and achieves the practical advancement of providing a heat dissipating device having a simple structure, small size, short manufacturing time and low cost.

Another objective of the present invention lies in: A plurality of protruding portions are formed on the periphery of the circuit substrate, and the circuit substrate is mounted with at least one light-emitting element. A plurality of the heat dissipating plates are stacked together and located on the reverse side of the circuit substrate, and a plurality of protruding portions are formed on the peripheries of the heat dissipating plates. Moreover, the circuit substrate is joined to the heat dissipating plates using a rivet fixing means. Accordingly, the appearance of a lotus blossom is formed after the circuit substrate and the heat dissipating plates are joined together using rivets. Furthermore, when the light-emitting elements are activated, the protruding portions at the same time provide an aesthetic function, thereby enabling greater likeness to a lotus lamp.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a heat dissipating structure for a LED light fitting of the prior art.

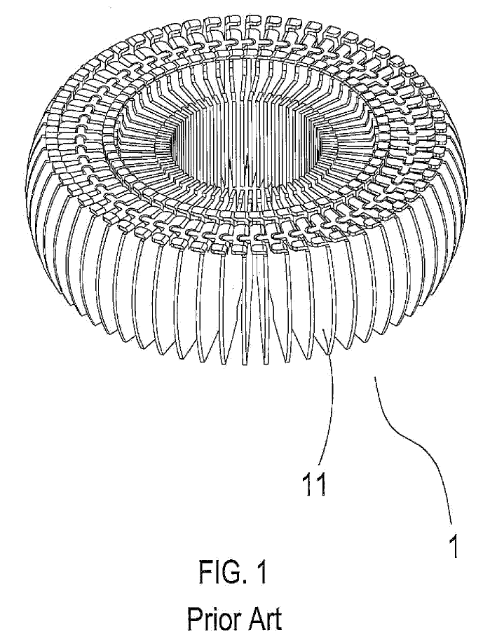

FIG. 2 is an elevational view of a preferred embodiment of the present invention.

FIG. 3 is an exploded view of the preferred embodiment of the present invention.

FIG. 4 is an operational schematic view of the preferred embodiment of the present invention.

FIG. 5 is an implementation schematic view of another embodiment of the present invention.

FIG. 6 is an implementation schematic view of yet another embodiment of the present invention.

### DETAILED DESCRIPTION OF THE PREFERRED EMBODIMENTS

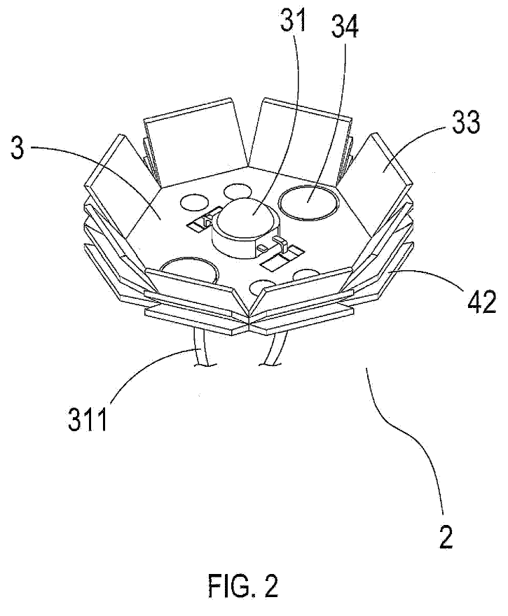

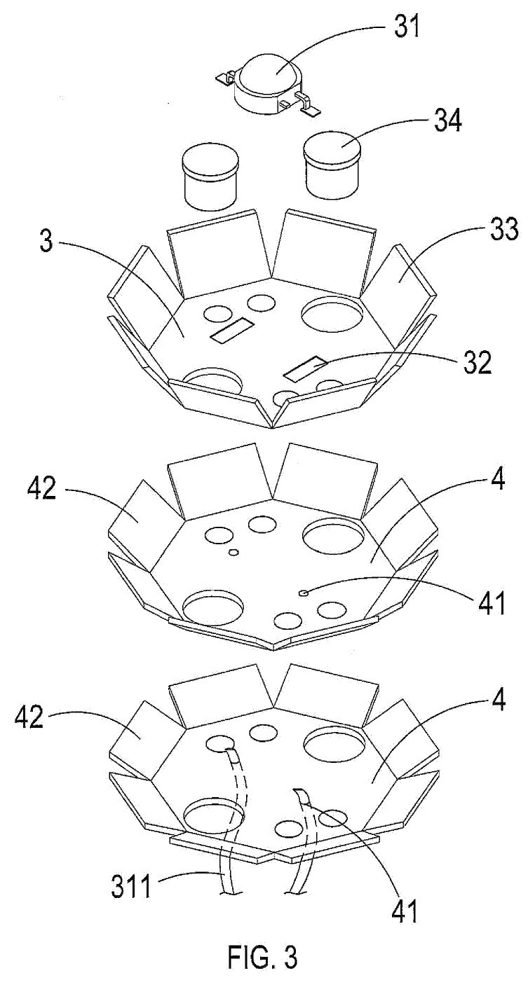

Referring to FIG. 2 and FIG. 3, which show an elevational view and an exploded view respectively of a preferred embodiment of the present invention, and it can be clearly seen from the drawings that a heat dissipating device 2 comprises:

A circuit substrate 3, on which is mounted at least one light-emitting element 31, and the light-emitting elements 31 can be either light-emitting diodes (LEDs) or halogen lamps, and an electrical element 311 used to realize electric conduction extends from each of the light-emitting elements 31. The circuit substrate 3 is provided with a plurality of holes 32 to enable the electrical elements 311 to pass therethrough. Furthermore, a plurality of protruding portions 33 are formed on the periphery of the circuit substrate 3.

At least one heat dissipating plate 4, one side of which is connected to the reverse side of the circuit substrate 3. The heat dissipating plates 4 is able to conduct away the heat energy produced by the light-emitting elements 31, and a stacking method is used to additionally assemble a plurality of the heat dissipating plates 4, thereby substantially improving the heat conduction effect. In addition, the heat dissipating plates 4 are further provided with coinciding holes 41 corresponding to the holes 32. The coinciding holes 41 enable the electrical elements 311 to penetrate therethrough, thereby enabling unimpeded electric conduction through to the electrical elements 311 via the reverse side of the circuit substrate 3. Moreover, the heat dissipating plates 4 are made from metallic material having high heat conductivity, which is either copper or aluminum. Such metallic material having high heat conductivity provides the heat dissipating plates 4 with better heat dissipation effectiveness. Furthermore a plurality of protruding portions 42 are formed on the periphery of the heat dissipating plates 4. Accordingly, when the circuit substrate 3 is joined to the heat dissipating plates 4, the aforementioned protruding portions 33, 42 are used to form an extremely fashionable and distinctive lotus blossom configuration. Hence, according to the aforementioned structure, it can be known that the heat dissipating device 2 is provided with the advantages of being small in size, having high extensionality, which along with its simple structure enables costs to be substantially reduced.

Furthermore, the circuit substrate 3 is provided with fixing portions 34, and the fixing portions 34 are used to fixedly secure the joining together of the heat dissipating plates 4 and the circuit substrate 3. The fixing portions 34 can use either rivets or bonding means to effect the joining together.

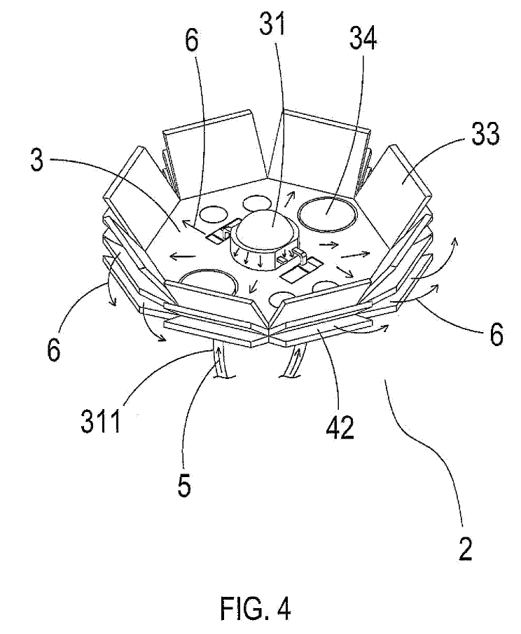

According to the aforementioned structure and constructional design, circumstances during operational use of the present invention are described hereinafter. Referring together to FIG. 3 and FIG. 4, which show the exploded view and an operational schematic view respectively of the preferred embodiment of the present invention, and it can be clearly seen from the drawings that a plurality of the protruding portions 33 are formed on the periphery of the circuit substrate 3, and that the circuit substrate 3 is mounted with at least one of the light-emitting elements 31. The electrical elements 311 used to realize electric conduction respectively extend from the light-emitting elements 31, and the electrical elements 311 activate the light-emitting elements 31. Moreover, the circuit substrate 3 is provided with a plurality of the holes 32 to enable the electrical elements 311 to pass therethrough. Moreover, the reverse side of the circuit substrate 3 is fitted with a plurality of the heat dissipating plates 4, and the heat dissipating plates 4 are provided with the coinciding holes 41 corresponding to the holes 32. The coinciding holes 41 enable the electrical elements 311 to pass therethrough, and a plurality of the protruding portions 42 are formed on the periphery of the heat dissipating plates 4. After firmly joining the circuit substrate 3 using the fixing portions 34, then the structural configuration of the aforementioned protruding portions 33, 42 enables the heat dissipating device 2 to have the form of a lotus blossom. After the electrical elements 311 realize electric conduction, then electric current 5 flows to the light-emitting elements 31 through the electrical elements 311, thereby conducting electricity to the light-emitting elements 31, which immediately begin emitting light while at the same time producing heat energy 6, whereupon, the heat energy 6 undergoes heat exchange with the heat dissipating plates 4 and is conducted away. Moreover, the more the number of the heat dissipating plates 4 stacked together, the better the heat dissipation effectiveness.

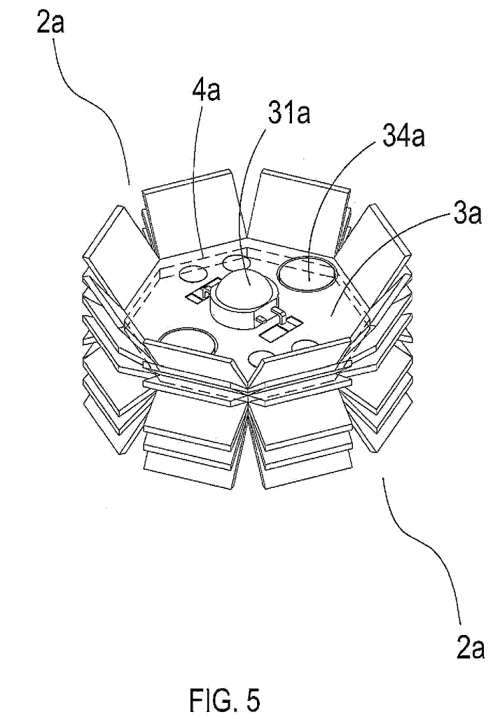

Referring to FIG. 5, which shows an implementation schematic view of another embodiment of the present invention, and it can be clearly seen from the drawing that a circuit substrate 3a is fitted with at least one light-emitting element 31a, and a reverse side of the circuit substrate 3a is fitted with at least one heat dissipating plate 4a. The heat dissipating plates 4a are joined to the circuit substrate 3a using fixing portions 34a, and another side of the heat dissipating device 2a can be additionally joined to another heat dissipating device 2a fitted in a reverse direction, thereby enabling the heat dissipating devices 2a to be assembled in different configurations.

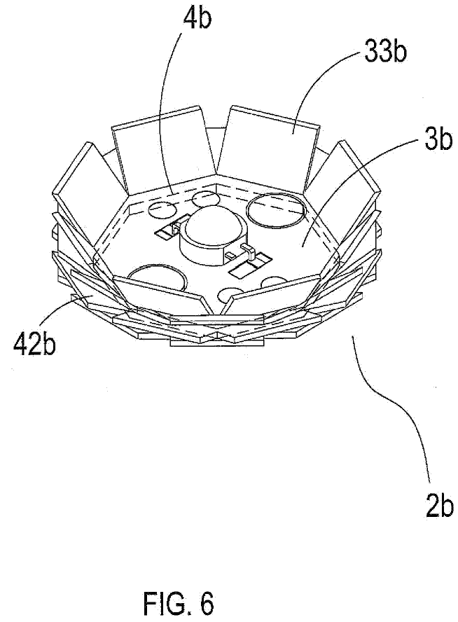

Referring to FIG. 6, which shows an implementation schematic view of yet another embodiment of the present invention, and it can be clearly seen from the drawing that a heat dissipating device 2b comprises a circuit substrate 3b and at least one heat dissipating plate 4b. A plurality of protruding portions 33b are formed on the periphery of the circuit substrate 3b, and a plurality of protruding portions 42b are also formed on the periphery of the heat dissipating plates 4b. Moreover, using different angled configurational arrangements enables the heat dissipating device 2b to be fabricated to have the form of a lotus blossom.

Hence, referring to all the drawings, compared to the prior art, the following advantages exist when using the present invention:

1. When manufacturing the heat dissipating device 2, its simple structure enables reducing manufacturing man-hours, thereby achieving greater competitive strength.

2. Its simple structure enables reducing the entire manufacturing cost, thereby achieving the advantage of saving on cost.

3. Its small size enables realizing different designs within an effective range for use thereof, and thus has an extensive application area.

4. Uses rivets to fixedly secure the structure, thereby providing a simple and firm fixing means.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A lotus blossom heat dissipating device, wherein a heat dissipating device comprises:
a circuit substrate, the circuit substrate is mounted with at least one light-emitting element; and
at least one heat dissipating plate, one side of the heat dissipating plate is joined to the reverse side of the circuit substrate, the heat dissipating plate enables the heat energy produced by the light-emitting element to be conducted away, and a stacking method is used to additionally assemble a plurality of the heat dissipating plate.

2. The lotus blossom heat dissipating device according to claim 1, wherein a plurality of protruding portions are formed on the periphery of the circuit substrate.

3. The lotus blossom heat dissipating device according to claim 1, wherein an electrical element used to realize electric conduction extends from each of the light-emitting elements.

4. The lotus blossom heat dissipating device according to claim 1, wherein the circuit substrate is provided with a plurality of holes to enable the electrical elements to pass therethrough.

5. The lotus blossom heat dissipating device according to claim 1, wherein the light-emitting element is either a light-emitting diode (LED) or a halogen lamp.

6. The lotus blossom heat dissipating device according to claim 1, wherein a plurality of protruding portions are formed on the periphery of the heat dissipating plate.

7. The lotus blossom heat dissipating device according to claim 1, wherein the heat dissipating plate is made from metallic material having high heat conductivity.

8. The lotus blossom heat dissipating device according to claim 7, wherein the metallic material having high heat conductivity is either copper or aluminum.

9. The lotus blossom heat dissipating device according to claim 1, wherein the heat dissipating plate is provided with coinciding holes corresponding to the holes.

10. The lotus blossom heat dissipating device according to claim 1, wherein the circuit substrate is provided with fixing portions.

11. The lotus blossom heat dissipating device according to claim 10, wherein either rivets or bonding means are used as the fixing portions.
